(19) United States
(12) Patent Application Publication
(10) Pub. No.: US 2014/0129194 A1
(43) Pub. Date: May 8, 2014

(54) METHODS OF THREE-DIMENSIONAL POTENTIAL FIELD MODELING AND INVERSION FOR LAYERED EARTH MODELS

(71) Applicant: TechnoImaging, LLC., Salt Lake City, UT (US)

(72) Inventor: Michael S. Zhdanov, Holladay, UT (US)

(73) Assignee: Technolmaging, LLC., Salt Lake City, UT (US)

(21) Appl. No.: 14/071,326

(22) Filed: Nov. 4, 2013

Related U.S. Application Data
(60) Provisional application No. 61/721,864, filed on Nov. 2, 2012.
(60) Provisional application No. 61/721,832, filed on Nov. 2, 2012.

(51) Int. Cl. G01V 99/00

(52) U.S. Cl. CPC G01V 99/005
USPC 703/2; 703/6

(57) ABSTRACT

A method for 3D modeling and inversion of potential field geophysical survey data measured above a geological formation having density and/or magnetization and/or susceptibility is described, using potential field data including but not limited to gravity and/or magnetic scalar and/or vector and/or tensor data. The 3D earth model is parameterized in terms of spatially variable contrast surfaces between different geological formations which are characterized by physical properties such as density and/or magnetization and/or susceptibility values and/or functions. The properties of the 3D earth model may be constrained from a priori information. The potential field responses and/or Frechet derivatives (sensitivities) of the spatially variable contrast surfaces between different geological formations and/or physical properties are analytically evaluated using Cauchy-type integral representations of the potential fields for each of the contrast surfaces.

### CROSS-REFERENCE TO RELATED APPLICATIONS

This application is a non-provisional of, and claims priority to and the benefit of, U.S. Patent Application Ser. No. 61/721,864 filed on Nov. 2, 2012 and entitled “METHODS OF THREE-DIMENSIONAL POTENTIAL FIELD MODELING AND INVERSION FOR LAYERED EARTH MODELS,” and U.S. Patent Application Ser. No. 61/721,832 filed on Nov. 2, 2012 entitled “METHODS OF THREE-DIMENSIONAL POTENTIAL FIELD MODELING AND INVERSION FOR LAYERED EARTH MODELS,” both of which are hereby expressly incorporated herein by this reference in their entireties. This application hereby incorporates the following publications by reference in their entireties: Parker, R. L., 1973, The rapid calculation of potential anomalies, Geophysical Journal of the Royal Astronomical Society, 31, 447-455. Zhdanov, M. S., 1988, Integral transforms in geophysics: Springer-Verlag, Berlin. Zhdanov, M. S., 2002, Geophysical inverse theory and regularization problems: Elsevier, Amsterdam.

### BACKGROUND OF THE INVENTION

1. The Field of the Invention

The present disclosure relates in general to methods of three-dimensional (3D) modeling and inversion of potential field geophysical survey data, particularly gravity, gravity gradiometry, magnetic, and magnetic gradiometry data.

2. The Relevant Technology

Potential field geophysical surveys are performed by measuring at least one component of the scalar and/or vector and/or tensors of a potential field. Potential field geophysical surveys are widely used for mapping subsurface geological and man-made structures in mineral, hydrocarbon, geothermal and groundwater exploration, and hydrocarbon, geothermal and groundwater resource monitoring, earth systems modeling, and tunnel and underground facility (UGF) detection.

Potential field data are processed prior to modeling and inversion. Processing may include but not be limited to diurnal corrections, drift corrections, terrain corrections, leveling, filtering, upward continuation, downward continuation, reduced to-pole corrections, and regional field removal. These types of data processing are often completed as part of the data acquisition, and prior to delivery of data.

One state-of-the-art method for 3D potential field modeling and inversion involves calculating the response (and sensitivity) in the spatial domain due to the 3d earth model discretized using a regular or irregular grid of right rectangular prisms—(“cells”) which are populated with a constant physical property such as density, susceptibility, and/or magnetization, as exemplified by Zhdanov, 2002. Expressions for the potential field responses (and sensitivities) of each cell contain volume integrals, and these may be evaluated using analytical or numerical techniques.

Another state-of-the-art method for 3D potential field modeling and inversion involves calculating the potential field responses in the Fourier (or wavenumber) domain due to the 3d earth model discretized using polygonal bodies. Expressions for the potential field response of each cell contain Fourier transforms, and these may be evaluated using numerical techniques such as Fast Fourier Transforms (FFTs) as exemplified by Parker, 1973. Each polygonal body is populated with a constant physical property such as density, susceptibility, and/or magnetization. In some applications, for example for sedimentary basins, the polygon is populated with a spatially variable physical property, e.g., a density increasing with depth.

Despite the widespread use of the aforementioned state-of-the-art methods, there is one consistent and distinct disadvantage to all of the aforementioned state-of-the-art methods. The Frechet derivatives (sensitivities) of the spatial points defining a surface which describes the interface between two geological formations cannot be analytically derived. Rather, the Frechet derivatives (sensitivities) of the spatial points defining a surface which describes the interface between two geological formations must be evaluated numerically, and this can be computationally inefficient and introduce significant numerical errors.

There remains a need to develop methods of 3D modeling and inversion of potential field data whereby the Frechet derivatives (sensitivities) of the spatial points defining a surface which describes the interface between two geological formations can be analytically derived. There remains a need for such a method to 3D modeling and inversion of potential field data to be generalized to include multiple surfaces so as to capture geological complexity relevant to geophysical exploration such as sub-salt and sub-basalt hydrocarbon exploration.

### BRIEF SUMMARY OF THE INVENTION

The embodiments disclosed herein are related to systems, methods, and computer readable media for inversion of layered earth model of 3D potential field geophysical data measured from at least one potential field sensor at at least one measurement position. The systems, methods and computer readable media include measuring at least one component of gravity and/or magnetic vector and/or tensor data with at least one potential field sensor in at least one measurement position along at least one survey line. The 3D earth model is parameterized in terms of multiple contrast surfaces between different geological formations. Each geological formation is characterized by a density and/or magnetization and/or susceptibility value and/or function. An appropriate physical property function is selected to describe the physical property distribution within each geological formation. The potential field (gravity and/or magnetic) data is inverted for the shapes of the multiple contrast surfaces between different geological formations.

### BRIEF DESCRIPTION OF THE DRAWINGS

Exemplary embodiments of the invention will become more fully apparent from the following description and appended claims, taken in conjunction with the accompanying drawings. Understanding that these drawings depict only exemplary embodiments and are, therefore, not to be considered limiting of the invention's scope, the exemplary embodiments of the invention will be described with additional specificity and detail through use of the accompanying drawings in which:

FIG. 1 illustrates an embodiment of a method for 3D potential field inversion.

FIG. 2 illustrates an embodiment of a processor for 3D potential field inversion.

FIG. 3 illustrates the parameterization of the 3D earth model for calculating the response and Frechet derivatives (sensitivities) of the measured potential field data.

FIG. 4 illustrates a perspective view of a 3D earth model consisting of a sediment layer with uniform density of 2.4 g/cm³ overlying a spatially variable basement layer with a uniform density of 2.8 g/cm³. The density contrast surface is the surface between the sediment and basement layers. The locations of observation points for a surface-based gravity survey are shown.

FIG. 5 illustrates a map of the vertical gravity vector component simulated for all observation points for a surface-based gravity survey over the 3D earth model.

FIG. 6 illustrates a density contrast surface between the sediment and basement layers in the 3D earth model as recovered from 3D inversion based on Cauchy-type integral representations.

FIG. 7 illustrates an embodiment of a system for three-dimensional potential field modeling and inversion for layered earth models including gravimeters and gravity gradiometers attached to a fixed wing aircraft that is moving along a survey line L(t) above the surface of the examined medium.

FIG. 8 illustrates an embodiment of a system for three-dimensional potential field modeling and inversion for layered earth models including gravimeters and gravity gradiometers attached to a vessel moving at some elevation along a survey line L(t) above the surface of the examined medium.

FIG. 9 illustrates an embodiment of a system for imaging including sensors located above the surface of the examined medium.

### DETAILED DESCRIPTION

Exemplary embodiments of the invention will become more fully apparent from the following detailed description and appended claims, taken in conjunction with the accompanying drawings. It is understood that this discussion describes only exemplary embodiments and are, therefore, not to be considered limiting of the invention's scope.

Potential field geophysical data usually includes at least one component of the gravity and/or magnetic vector and/or tensor measured from stationary sensors and/or moving platforms such as but not limited to airplanes, helicopters, airships, unattended aerial vehicles (UAV), borehole logging instruments, vessels, submarines, and vehicles.

For the purpose of interpreting potential field data, the potential field data are inverted for a 3D earth model. In at least one embodiment of a method disclosed herein, the 3D earth model is parameterized in terms of multiple contrast surfaces between different geological formations. Each geological formation is characterized by a density and/or magnetization and/or susceptibility value and/or function. A priori information, such as density and/or magnetization and/or susceptibility values and/or functions, contrast surfaces defined by seismology, and contrast surfaces defined by drilling information, can be used to construct and/or constrain 3D earth models.

At least one embodiment of a method disclosed herein inverts for the shapes of the multiple contrast surfaces between different geological formations. Contrast surfaces which are known a priori (e.g., topography, bathymetry, from seismology or drilling) may be constrained during 3D inversion. The potential field responses for each contrast surface are evaluated using Cauchy-type integral representations of the potential fields for each of the contrast surfaces. The Frechet derivatives (sensitivities) of the spatial points defining the contrast surface between two geological formations are derived analytically using Cauchy-type integral representations of the potential fields for each of the contrast surfaces.

At least one embodiment of a method disclosed herein inverts for the physical properties (density and/or magnetization and/or susceptibility) of each geological formation. The potential field responses for each contrast surface are evaluated using Cauchy-type integral representations of the potential fields for each of the contrast surfaces. The Frechet derivatives (sensitivities) of the physical properties defining each geological formation are derived analytically using Cauchy-type integral representations of the potential fields for each of the contrast surfaces.

At least one embodiment of a method disclosed herein can be applied to gravity scalar and/or vector and/or tensor data.

At least one embodiment of a method disclosed herein can be applied to magnetic scalar and/or vector and/or tensor data.

At least one embodiment of a method disclosed herein can be applied to the joint inversion of gravity and magnetic scalar and/or vector and/or tensor data.

At least one embodiment of this method can be used in geophysical exploration for mineral, hydrocarbon, geothermal, and groundwater resources, and for earth systems.

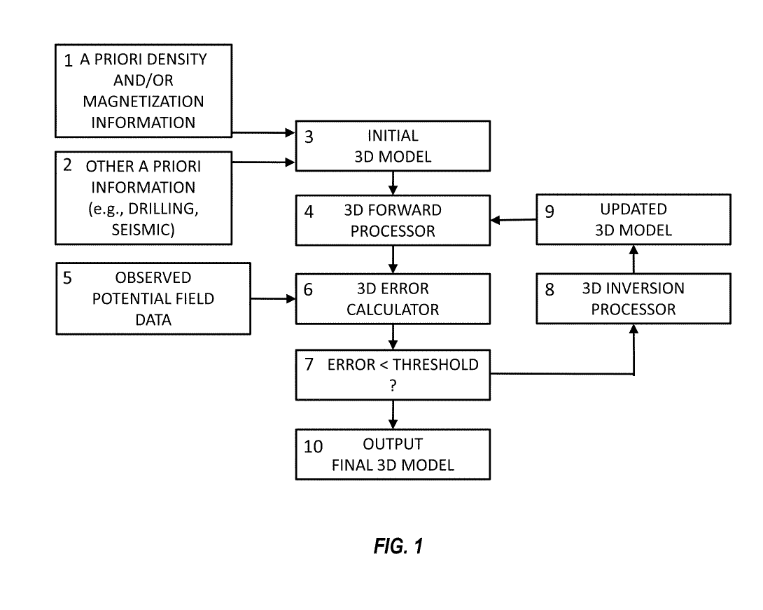

An embodiment of a method for 3D inversion of potential field data is schematically shown in FIG. 1. A priori density and/or magnetization and/or susceptibility information 1, including but not limited to numerical values and functions, is used to define the density and/or magnetization and/or susceptibility properties of each geological formation in a 3D earth model. Other a priori information 2 such as reflection seismic surfaces and/or drilling information can be used to define the contrast surfaces between different geological formations in the 3D earth model. An initial 3D earth model 3 appropriate for 3D forward modeling is constructed from a priori density and/or magnetization and/or susceptibility information 1 and other a priori information 2. The 3D forward processor 4 computes the predicted potential field data using Cauchy-type integral representations of the potential fields for each of the contrast surfaces. The misfit between the observed potential field data 5 and the predicted potential field data computed from the 3D forward processor 4 is evaluated with a 3D error calculator. If the misfit is above an accepted tolerance 7, the 3D inversion processor 8 calculates the Frechet derivatives (sensitivities) and the Tikhonov parametric functional is minimized. The 3D inversion processor 8 computes the Frechet derivatives (sensitivities) using Cauchy-type integral representations of the potential fields for each of the contrast surfaces. The 3D inversion processor 8 produces an updated 3D earth model 9, which is returned to the 3D forward processor 4. This process is iterated until the misfit is below an accepted tolerance, when a final 3D earth model 10 is produced.

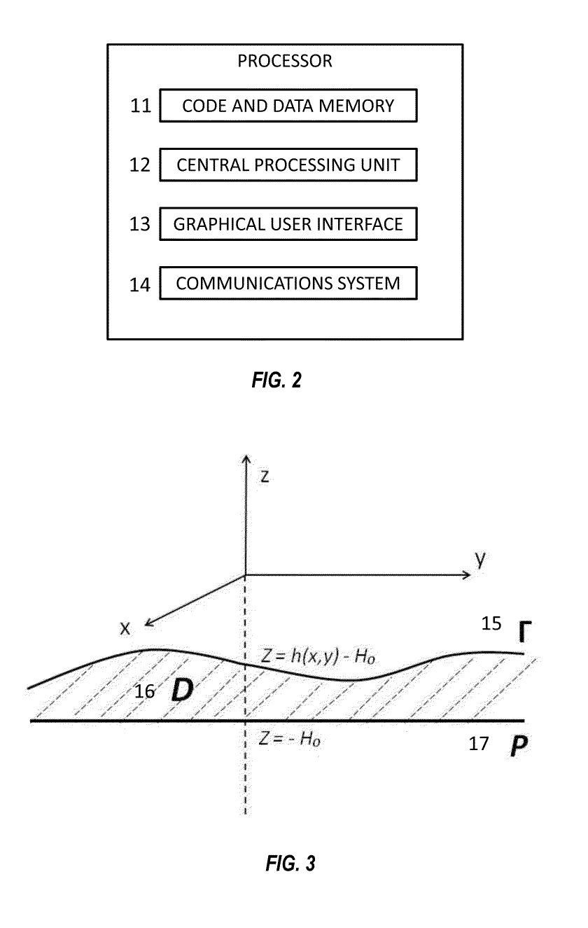

An embodiment of a processor is illustrated in FIG. 2. The processor may include, for example, a data and code memory 11 for storing potential field data, other geophysical data, 3D earth models, and 3D modeling and inversion computer software, a central processing unit 12 for executing the 3D modeling and inversion computer software to predict potential field data and 3D earth models, a graphical user interface (GUI) 13 for displaying the potential field data and/or 3D earth models, and a communications system 14 for system interoperability. The processor may comprise of a single processing unit or can be distributed across one or more processing units in one or more locations. The communications system 14 can include I/O interfaces for exchanging information with one or more external devices. The data and code memory 11 may comprise of a single memory device or can be distributed across one or more memory devices in one or more locations connected via the communications system 14.

The concept of a three-dimensional Cauchy-type integral was introduced by Zhdanov, 1988, and is represented by the following expression:

$${C}^{S} ( {r}^{′} , ϕ ) = - \frac{1}{4 π} {\int \int }_{S} [ ( n \cdot ϕ ) ∇ \frac{1}{\vert r - {r}^{′} \vert} + ( n \times ϕ ) \times ∇ \frac{1}{\vert r - {r}^{′} \vert} ] d s , \qquad ( 1 )$$

where S is some closed surface, φ=φ(r) is some vector function specified on S and is continuous on S, and n is a unit vector of the normal to S directed outside the domain D, bounded by the surface S. Function φ is called a vector density of the Cauchy-type integral C⁵(r, φ).

The Cauchy-type integral C⁵(r, φ) can be represented in matrix notation. The vectors C⁵, φ, n, and

$$∇ \frac{1}{\vert r - {r}^{′} \vert}$$

are presented in some Cartesian basis {dₓ, d_{y}, d_{z}}, where the z axis is directed upward, as:

$${C}^{S} = {C}_{α}^{S} {d}_{α} , \\ ϕ = {ϕ}_{β} {d}_{β} , \\ n = {n}_{γ} {d}_{γ} , \\ ∇ \frac{1}{\vert r - {r}^{′} \vert} = - \frac{r - {r}^{′}}{{\vert r - {r}^{′} \vert}^{2}} = - \frac{{r}_{η} - {r}_{η}^{′}}{{\vert r - {r}^{′} \vert}^{3}} {d}_{η} ,$$

where r_{η}=η and α, β, γ, η=x, y, z, and where we use an agreement on summation that the twice recurring index indicates the summation over this index. Using these notations, equation (1) can be re-written as:

$${C}^{S} ( {r}^{′} , ϕ ) = - \frac{1}{4 π} {\int \int }_{S} {Δ}_{α β γ η} {ϕ}_{β} \frac{{r}_{η} - {r}_{η}^{′}}{\vert r - {r}^{′} \vert} {n}_{γ} d s , \qquad ( 2 )$$

where the four-index Δ-symbol is expressed in terms of the symmetric Kronecker symbol δ_{αβ}:

$${Δ}_{α β γ η} = {δ}_{α β} {δ}_{γ η} + {δ}_{α η} {δ}_{β γ} - {δ}_{α γ} {δ}_{β η} , {δ}_{α β} = \{ \begin{matrix}1 , α = β , \\ 0 , α \neq β .\end{matrix}$$

As illustrated in FIG. 3, we can consider a model with the density contrast at some surface Γ 15, representing a geological interface such as the sediment-basement contrast of a sedimentary basin. We can consider a domain D 16 that is infinitely extended in the horizontal directions bounded by the surface Γ, described by equation z=h(x,y)−H₀, and a horizontal plane P 17, z=h₀, where H₀≧h(x. y)≧0 and:

h(x, y)−H₁→0 for\sqrt{x²+y²→∞}

where H₁ is a constant.

It can be shown that the gravity field, g, of the infinitely extended domain can be represented by the following Cauchy-type integral:

g(r′)=4πγρ₀C^{Γ}(r′, (z+H₀)d_{g}).

which can be re-written using matrix notation for the Cauchy integral from equation 2:

$${g}_{α} ( {r}^{′} ) = - γ {ρ}_{0} {\int \int }_{S} {Δ}_{α β γ η} ( z + {H}_{0} ) \frac{{r}_{η} - {r}_{η}^{′}}{{\vert r - {r}^{′} \vert}^{3}} {n}_{γ} d s . \qquad ( 3 )$$

We can provide explicit expressions for the components of the gravity field of the density contrast surface, taking into account the following relations for the components of the unit normal vector to the surface Γ:

$${n}_{x} d s = - \frac{\partial h ( x , y )}{\partial x} d x d y = {b}_{x} ( x , y ) d x d y , \\ {n}_{y} d s = - \frac{\partial h ( x , y )}{\partial y} d x d y = {b}_{y} ( x , y ) d x d y , \\ {n}_{z} d s = {b}_{z} ( x , y ) d x d y , \\ ( z + {H}_{0} ) = Δ z ( x , y ) , \qquad ( 5 )$$

where:

$${b}_{x} ( x , y ) = - \frac{\partial h ( x , y )}{\partial y} , \\ {b}_{y} ( x , y ) = - \frac{\partial h ( x , y )}{\partial y} , \\ {b}_{z} ( x , y ) = 1.$$

Substituting equation (5) into equations (3) and (4), we obtain:

$${g}_{α} ( {r}^{′} ) = - γ {ρ}_{0} {\int \int }_{S} {Δ}_{α β γ η} h ( x , y ) \frac{{\tilde{r}}_{η} - {r}_{η}^{′}}{{\vert \tilde{r} - {r}^{′} \vert}^{3}} {b}_{γ} ( x , y ) d x d y , \qquad ( 6 )$$

for the gravity field, where:

|\tilde{r}−r′|={square root over ((x−x′)²+(y−y′)²+(h(x, y)−H₀−z′)²)},

\tilde{r}ₓ=x,

\tilde{r}_{y}=y,

\tilde{r}_{z}=h(x, y)−H₀.

To simulate sediment compaction and diagenesis causing a loss of porosity in sedimentary formations, densities are often parameterized from empirical observations using analytic density-depth functions obtained from geological interface forming the upper boundary of the sedimentary formation, e.g., topography or bathymetry. The variety of analytic density-depth functions in use span linear, quadratic, parabolic, exponential, hyperbolic and polynomial functions. In general, sedimentary formations can be estimated with a model having a vertically variable density:

ρ=ρ(z).

Sedimentary formations can also be estimated with a model having both vertically and horizontally variable density:

ρ=ρ(x, y, z),

It can be shown that the gravity field, g, of an infinitely extended domain can be represented as the following Cauchy-type integral:

g(r′)=4πγρ₀C^{r}(r′, [R(z)−R(−H₀)]d_{g}), (8)

where R(x, y, z) is the indefinite integral of the vertically variable density:

R(z)=∫ρ(z)dz.

Equation (8) can be re-written using matrix notation for the Cauchy integral from equation 2:

$${g}_{α} ( {r}^{′} ) = - γ {ρ}_{0} {\int \int }_{S} {Δ}_{α β γη} [ R ( z ) - R ( - {H}_{0} ) ] \frac{{r}_{η} - {r}_{η}^{′}}{{\vert r - {r}^{′} \vert}^{3}} {n}_{γ} d s . \qquad ( 9 )$$

One can derive explicit expressions for the gravity fields of the density contrast surface, taking into account equation (5) for the components of the unit normal vector to the surface, Γ:

$${g}_{α} ( {r}^{′} ) = - {γρ}_{0} \int {\int }_{S} {Δ}_{αβγη} [ R ( z ) - R [ - {H}_{0} ) ] \frac{{\tilde{r}}_{η} - {r}_{η}^{′}}{{\vert \tilde{r} - {r}^{′} \vert}^{3}} {b}_{γ} ( x , y ) d s , \qquad ( 11 )$$

As an example of an embodiment of the method, one can consider a sedimentary formation with linear variations in the density with depth:

ρ(z)=ρ₀+az,

such that:

$$R ( z ) = {ρ}_{0} z + \frac{1}{2} {az}^{2} .$$

As another example of an embodiment of the method, one can consider a sedimentary formation with exponential variations in the density with depth:

ρ(z)=ρ₀+α exp(kz),

such that:

$$R ( z ) = {ρ}_{0} z + \frac{a}{k} exp ( kz )$$

The Cauchy-type surface integral equation 6 can be discretized by dividing the horizontal integration plane XY into a rectangular grid of Nₘ cells with constant discretization of Δx and Δy in the x and y directions, respectively. In each cell pₖ(k=1,2, . . . Nₘ), it is assumed that the corresponding part of the density contrast surface can be represented by an element of a plane described by the following equation:

z=h(x, y)−H₀=h^{(k)}−bₓ^{(k)}(x−xₖ)−b_{y}^{(k)}(y−yₖ)−H₀,

where (x, y) ∈ Pₖ and xₖ, yₖ) denotes the center of the cell Pₖ. In this case:

bₓ(x, y)=bₓ^{(k)},

b_{y}(x, y)=b_{y}^{(k)},

bₓ(x, y)=bₓ^{(k)}=1.

where (x, y) ∈ Pₖ. Equation 6 for the gravity field now takes the form:

$${g}_{α} ( {r}^{′} ) = - {γρ}_{0} {\sum }_{k = 1}^{{N}_{m}} {\int }_{{p}_{k}} \int {Δ}_{α z γη} h ( x , y ) \frac{{\tilde{r}}_{η} - {r}_{η}^{′}}{{\vert \tilde{r} - {r}^{′} \vert}^{3}} {b}_{y}^{( k )} d x d y . \qquad ( 13 )$$

Using the discrete model parameters introduced above, and discrete gravity data, g_{α}(r′), we can represent the 3D forward modeling operator for the gravity field of the density contrast surface Γ, equation 8, as:

$${g}_{α} ( {r}^{′} ) = {\sum }_{k = 1}^{{N}_{m}} {f}_{αγ}^{( nk )} {h}^{( k )} {b}_{γ}^{( k )} , \qquad ( 14 )$$

where:

$${f}_{αγ}^{( nk )} = - {γρ}_{0} {Δ}_{α z γη} \frac{{\tilde{r}}_{η}^{( k )} - {r}_{η}^{{( n )}^{′}}}{{\vert {\tilde{r}}_{k} - {r}_{η}^{′} \vert}^{3}} Δ x Δ y , \\ and \text{:}$$

$$\vert {\tilde{r}}_{k} - {r}_{η}^{′} \vert = \sqrt{{( {x}_{k} - {x}_{n}^{′} )}^{2} + ( {y}_{k} - {y}_{n}^{′} ) + {( {h}^{( k )} - {H}_{0} - {z}_{n}^{′} )}^{2}} , \\ {\tilde{r}}_{x}^{( k )} = {x}_{k} , \\ {\tilde{r}}_{y}^{( k )} = {y}_{k} , \\ {\tilde{r}}_{z}^{( k )} = {h}^{( k )} - {H}_{0} , \\ {\tilde{r}}_{x}^{( n ) ′} = {x}_{n}^{′} , \\ {\tilde{r}}_{y}^{( n ) ′} = {y}_{n}^{′} , \\ {\tilde{r}}_{z}^{( n ) ′} = {z}_{n}^{′} .$$

In the special case where we can approximate the density contrast surface Γ within every cell Pₖ by a horizontal element, then:

z=h(x, y)−H₀=h^{(k)}−H₀,

where (x, y) ∈ Pₖ and the coefficients bₓ^{(k)}=b_{y}^{(k)}=0 and b_{z}^{(k)}=1, and equation 13 can be simplified to

$${g}_{α} ( {r}^{′} ) = - {γρ}_{0} {\sum }_{k = 1}^{{N}_{m}} {\int }_{{p}_{k}} \int {Δ}_{α z z η} {h}^{( k )} \frac{{\tilde{r}}_{η} - {r}_{η}^{′}}{{\vert \tilde{r} - {r}^{′} \vert}^{3}} d x d y . \qquad ( 15 )$$

Since:

Δ_{axzη}=δ_{az}δ_{zη}+δ_{aη}δ_{zz}−δ_{αz}δ_{βz}=δ_{αη},

Equation 15 takes the form:

$${g}_{α} ( {r}^{′} ) = {\sum }_{k = 1}^{{N}_{m}} {f}_{α}^{( nk )} {h}^{( k )} , \qquad ( 16 )$$

where:

$${f}_{α}^{( nk )} = - {γρ}_{0} {δ}_{αη} \frac{{\tilde{r}}_{η}^{( k )} - {r}_{η}^{{( n )}^{′}}}{{\vert {r}_{k} - {r}_{η}^{′} \vert}^{3}} Δ x Δ y ,$$

To invert vertical components of the gravity field for the depths of the density contrast surface, the vertical component of the gravity field is given by:

$$\begin{matrix}{g}_{z} ( {r}^{′} ) = {\sum }_{k = 1}^{{N}_{m}} {f}_{z}^{( nk )} {h}^{( k )} \\ = A ( {h}_{1} , {h}_{2} , … , {h}_{{N}_{m}} ) \\ = A ( h ) ,\end{matrix} \qquad ( 17 )$$

where h=(h₁, h₂, . . . h_{N}_{ₘ}) is the Nₘ length vector of the depths for all Nₘ cells discretizing the density contrast surface, and represents the unknown model parameters that one intends to recover from inversion of the vertical components of the gravity field, and where:

$$\begin{matrix}{f}_{z}^{( nk )} = - {γρ}_{0} \frac{{h}^{( k )} - {H}_{0} - {z}_{n}^{′}}{{\vert {\tilde{r}}_{k} - {r}_{η}^{′} \vert}^{3}} Δ x Δ y \\ = - {γρ}_{0} \frac{{h}^{( k )} - {H}_{0} - {z}_{n}^{′}}{{[ {( {x}_{k} - {x}_{n}^{′} )}^{2} + {( {y}_{k} - {y}_{n}^{′} )}^{2} + {( {h}^{( k )} - {H}_{0} - {z}_{n}^{′} )}^{2} ]}^{3 / 2}} Δ x Δ y\end{matrix}$$

Introducing d=(d₁, d₂, . . . d_{N}_{_{d}}) as the N_{d} length vector of measured vertical components of the gravity field, we arrive at the conventional formulation of a nonlinear inverse problem:

d=A(h),

for which the solution may be obtained by minimizing the Tikhonov parametric functional, p^{α}(h):

p^{α}(h)=∥A(h)−d∥_{D}²+α∥h−hₐₚᵣ∥_{M}²→min (18)

where hₐₚᵣ is an Nₘ length vector of the a priori depths for all Nₘ cells discretizing the density contrast surface, and a is the Tikhonov regularization parameter introduced to provide balance (or bias) between the misfit and stabilizing functionals.

As discussed by Zhdanov, 2002, one may apply a deterministic (gradient-based) optimization method to minimize Tikhonov parametric functional 18. To do so, it is essential to evaluate the Frechet derivatives (sensitivities), which can be obtained from direct differentiation of the modeling operator 17:

$$\begin{matrix}{F}_{ni} = \frac{\partial {g}_{z} ( {r}_{n}^{′} )}{\partial {h}^{( l )}} \\ = \frac{\partial }{\partial {h}^{( i )}} {\sum }_{k = 1}^{{N}_{m}} {f}_{z}^{( nk )} {h}^{( k )} \\ = {\sum }_{k = 1}^{{N}_{m}} [ \frac{\partial {f}_{z}^{( nk )}}{\partial {h}^{( l )}} {h}^{( k )} + \frac{\partial {h}^{( k )}}{\partial {h}^{( i )}} {f}_{z}^{( nk )} ] ,\end{matrix} \qquad ( 19 )$$

where:

$$\frac{\partial {h}^{( k )}}{\partial {h}^{( l )}} = {δ}_{ki} \qquad ( 20 )$$

and:

$$\begin{matrix}\frac{\partial {f}_{z}^{( nk )}}{\partial {h}^{( l )}} {h}^{( k )} = - {γρ}_{0} Δ x Δ y \frac{\partial }{\partial {h}^{( l )}} [ \frac{{h}^{( k )} - {H}_{0} - {z}_{n}^{′}}{{\vert {\tilde{r}}_{k} - {r}_{n}^{′} \vert}^{3}} ] \\ = - {γρ}_{0} Δ x Δ y [ \begin{matrix}\frac{\partial }{\partial {h}^{( l )}} ( \frac{1}{{\vert {\tilde{r}}_{k} - {r}_{n}^{′} \vert}^{3}} ) ( {h}^{( k )} - {H}_{0} - {z}_{n}^{′} ) + \\ \frac{{δ}_{kl}}{{\vert {\tilde{r}}_{k} - {r}_{n}^{′} \vert}^{3}}\end{matrix} ] , \\ = {γρ}_{0} Δ x Δ y [ 3 \frac{( {h}^{( k )} - {H}_{0} - {z}_{n}^{′} )}{{\vert {\tilde{r}}_{k} - {r}_{n}^{′} \vert}^{3}} - \frac{1}{{\vert {\tilde{r}}_{k} - {r}_{n}^{′} \vert}^{3}} ] {δ}_{ki} .\end{matrix} \qquad ( 21 )$$

Substituting equations 20 and 21 into 19, one obtains:

$${F}_{nl} = \frac{{γρ}_{0} Δ x Δ y}{{\vert {\tilde{r}}_{l} - {r}_{n}^{′} \vert}^{3}} \{ 3 \frac{( {h}^{( l )} - {H}_{0} - {z}_{n}^{′} )}{{\vert {\tilde{r}}_{l} - {r}_{n}^{′} \vert}^{2}} {h}^{( l )} - ( 2 {h}^{( l )} - {H}_{0} - {z}_{n}^{′} ) \} , \qquad ( 22 )$$

Equation 22 is an analytic expression for the Frechet derivatives (sensitivities) of the spatial points defining a contrast surface which describes the interface between two geological formations.

In a similar manner, one can derive Cauchy-type expressions for the gravity gradient (tensor) components.

In at least one embodiment of the method, the Frechet derivatives may be evaluated for multiple surfaces within the same earth model, where each surface describes the interface between two geological formations.

In at least one embodiment of the method, the Frechet derivatives may also be evaluated for the density and/or density function describing a geological formation.

In a similar manner, where the physical property is magnetization and/or susceptibility, one can derive Cauchy-type expressions for the total magnetic intensity, magnetic vector components, and/or magnetic gradient (tensor) components for the magnetization contrast surface and/or susceptibility contrast surface.

In at least one embodiment of the method, the Frechet derivatives for at least one contrast surface may be evaluated for both gravity and magnetic scalar and/or vector and/or gradient (tensor) data, and the gravity and magnetic scalar and/or vector and/or gradient (tensor) data jointly inverted to recover the depths of the at least one contrast surface.

The Cauchy-type integrals are evaluated independently for each data at each observation location. In one embodiment of the method, the Cauchy-type integrals can be evaluated on a grid with increasing discretization that is a function of distance from the observation location, and which may terminate at some distance from the observation location that is determined from the integrated sensitivity of the data with respect to the 3D earth model.

### EXAMPLE

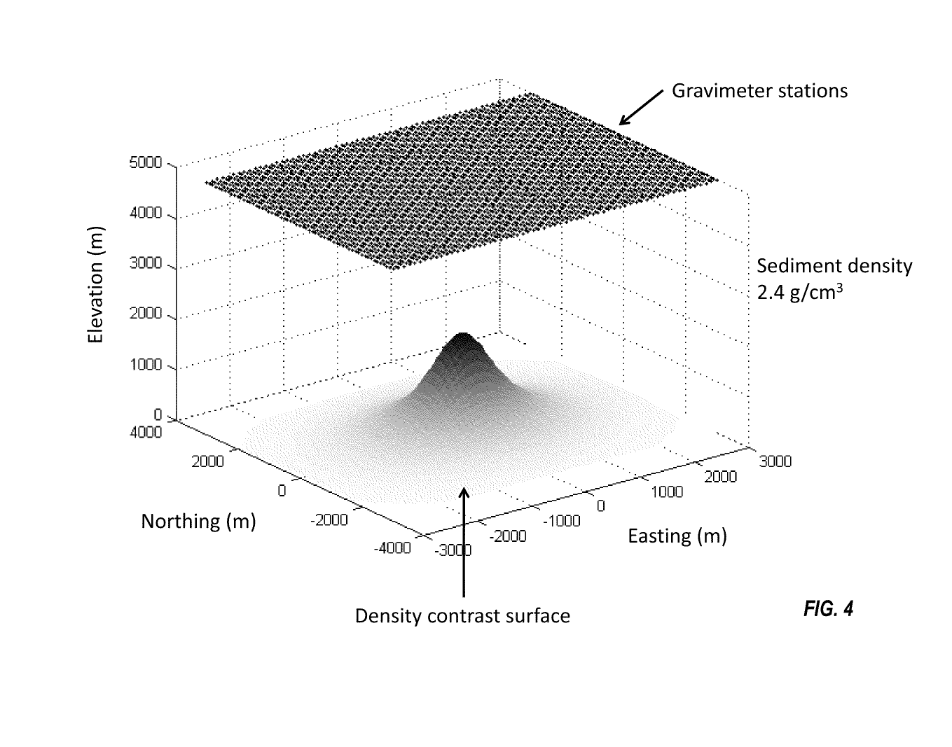

FIG. 4 presents a 3D earth model consisting of a sedimentary layer above a basement layer, for which the vertical component of the gravity field was evaluated. The sedimentary layer has a density of 2.4 g/cm³, and the basement layer has a density of 2.8 g/cm³. The spatially variable density contrast surface represents a 0.4 g/cm³ density contrast between the sedimentary layer and the basement layer.

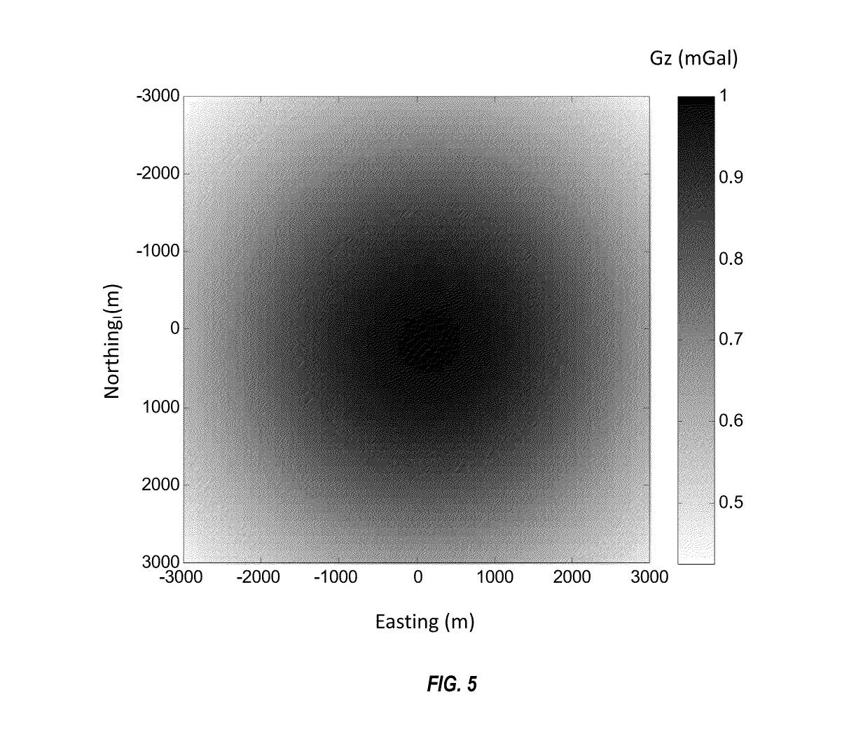

FIG. 5 presents a map of the vertical component of the gravity field computed for the 3D earth model shown in FIG. 4.

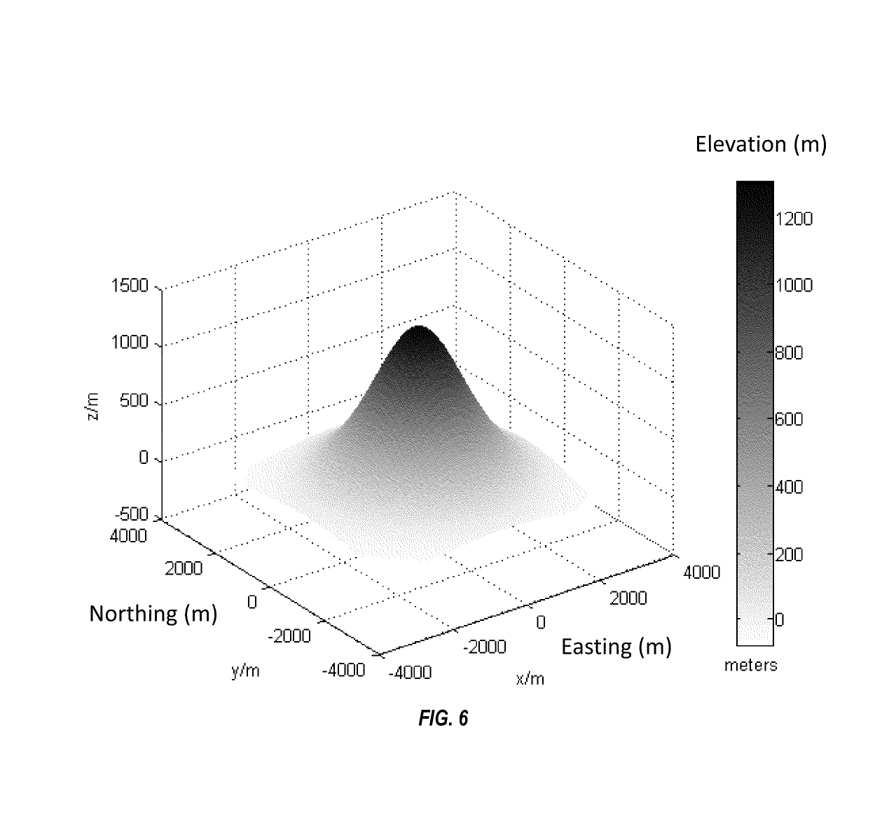

FIG. 6 presents a density contrast surface between the sediment and basement layers in the 3D earth model, shown in FIG. 4, as recovered from 3D inversion based on Cauchy-type integral representations.

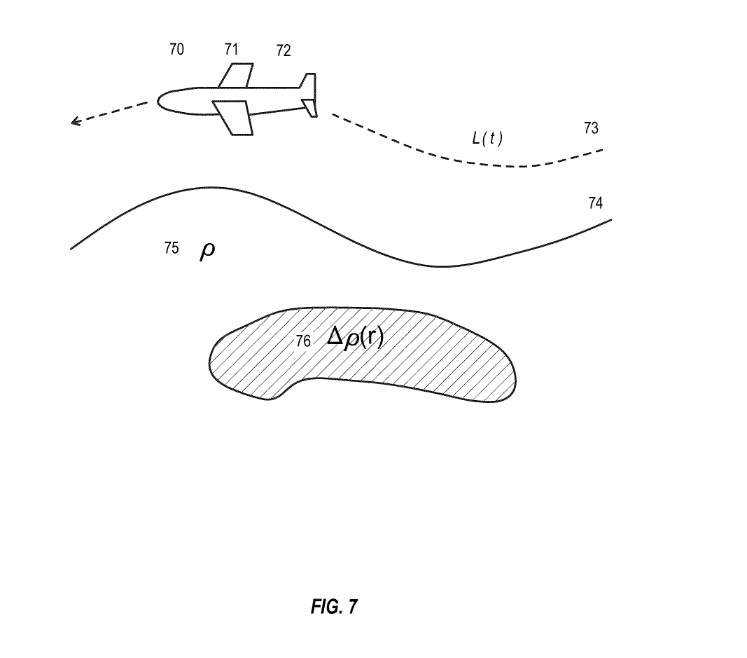

One system for performing the embodiments disclosed herein is illustrated in FIG. 7. A data acquisition system 70, located on a fixed wing aircraft 71, may include gravimeters and/or gravity gradiometers 72 attached to the fixed wing aircraft that is moving along a survey line L(t) 73 at some elevation above the surface of an examined medium 74 that may be characterized by a homogeneous terrain density 75 with an anomalous density distribution 76 superimposed upon it.

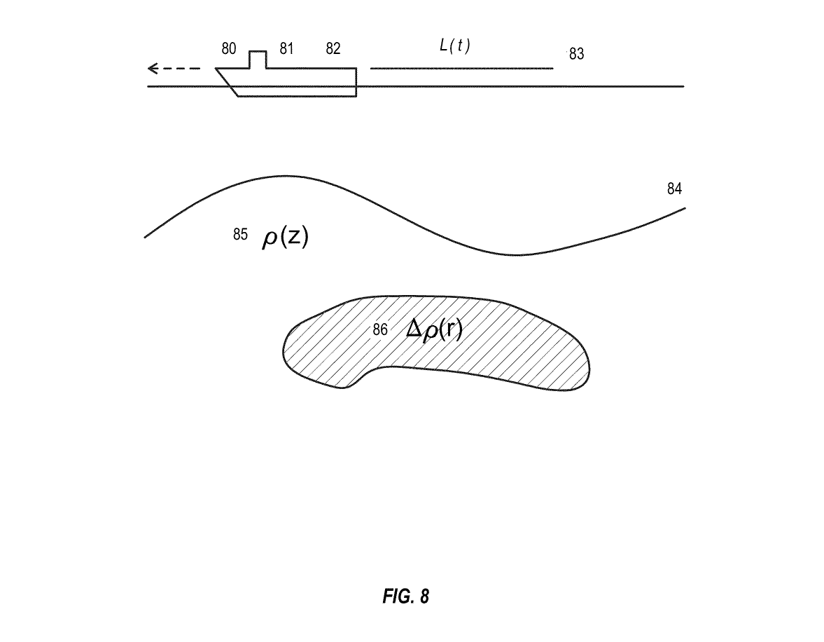

Another system for performing the embodiments disclosed herein is illustrated in FIG. 8. A data acquisition system 80, located on a vessel 81, may include gravimeters and/or gravity gradiometers 82 attached to the vessel that is moving along a survey line L(t) 83 at some elevation above the surface of an examined medium 84 that may be characterized by a terrain density that varies as a function of depth 85 with Qan anomalous density distribution 86 superimposed upon it.

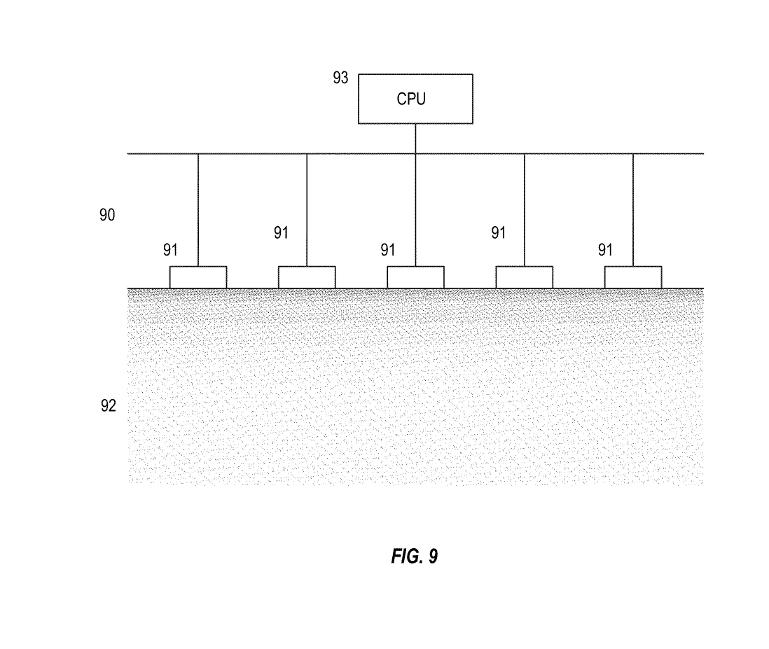

Yet another system for performing the embodiments disclosed herein is illustrated in FIG. 9. An image acquisition system 90 may include one or more sensors 91 that are located at some proximity of an examined medium 92. In one embodiment, the sensors 91 may be arranged as an array on the surface or within the examined medium 92. It will be appreciated that the sensors 91 may be arranged in any reasonable manner. In some embodiments, the sensors 91 may be seismic, electric, magnetic, gravity, acoustic, and/or temperature field sensors or any combination thereof. In other embodiments, the sensors 91 may be optical, electromagnetic, elastic, and/or radio wave signal sensors, gravimeters and/or gravity gradiometers and/or magnetometers and/or magnetic gradiometers or any combination thereof. It will be appreciated that the sensors 91 may be any reasonable type of sensor or combination of sensors as circumstances warrant. A processor 93, which may correspond to the processor illustrated previously in relation to FIG. 2, may operate the image acquisition system.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical non-transitory storage media. Computer-readable media that carry computer-executable instructions are transmission media. Thus, by way of example, and not limitation, embodiments of the invention can comprise at least two distinctly different kinds of computer-readable media: physical non-transitory storage media and transmission media.

Physical non-transitory storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to physical storage media (or vice versa). For example, computer-executable instructions or data structures received over a network or data link can be buffered in RAM within a network interface module (e.g., a “NIC”), and then eventually transferred to computer system RAM and/or to less volatile physical storage media at a computer system. Thus, it should be understood that physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. A method of inversion for layered earth model of 3D potential field geophysical data measured from at least one potential field sensor at at least one measurement position, the method comprising:
a. measuring at least one component of gravity and/or magnetic vector and/or tensor data with at least one potential field sensor in at least one measurement position along at least one survey line;
b. parameterizing the 3D earth model in terms of multiple contrast surfaces between different geological formations;
c. characterizing each geological formation by a density and/or magnetization and/or susceptibility value and/or function;
d. selecting an appropriate physical property function to describe the physical property distribution within each geological formation; and
e. inverting the potential field (gravity and/or magnetic) data for the shapes of the multiple contrast surfaces between different geological formations.

2. The method of claim 1, wherein the physical properties comprises one of density, susceptibility, and/or magnetization, representing the physical properties of the geological formations.

3. The method of claim 1, wherein the physical property function describing the physical property distribution within the geological formation is an analytic function of spatial coordinates.

4. The method of claim 1, wherein the forward modeling of the potential field data includes an algorithm based on Cauchy-type integral representations of the potential fields for each of the contrast surfaces.

5. The method of claim 1, wherein the inversion of the potential field data includes an algorithm based on the regularized gradient-type method, and the Frechet derivatives (sensitivities) of the data to the spatial points defining the contrast surface between two geological formations are derived analytically using Cauchy-type integral representations of the potential fields for each of the contrast surfaces.

6. The method of claim 1, wherein the inversion of the potential field data includes an algorithm based on the regularized method, constrained by a priori information about the known contrast surfaces defined by seismology, and/or by drilling information, and /or by other geological/geophysical data.

7. The method of claim 1, wherein the at least one potential field sensor comprises a plurality of potential field sensors arranged in an array.

8. The method of claim 3, wherein the plurality of potential field sensors include gravimeters and/or gravity gradiometers and/or magnetometers and/or magnetic gradiometers.

9. The method of claim 1, wherein the examined medium contains a geological structure.

10. The method of claim 1, further comprising:
placing at least one potential field sensor in at least one measurement position in a survey.

11. A physical non-transitory computer readable medium having stored thereon computer executable instructions that when executed by a processor cause a computing system to perform a method of inversion for layered earth model of 3D potential field geophysical data measured from at least one potential field sensor at at least one measurement position, the method comprising:
a. measuring at least one component of gravity and/or magnetic vector and/or tensor data with at least one potential field sensor in at least one measurement position along at least one survey line;
b. parameterizing the 3D earth model in terms of multiple contrast surfaces between different geological formations;
c. characterizing each geological formation by a density and/or magnetization and/or susceptibility value and/or function;
d. selecting an appropriate physical property function to describe the physical property distribution within each geological formation; and
e. inverting the potential field (gravity and/or magnetic) data for the shapes of the multiple contrast surfaces between different geological formations.

12. The method of claim 11, wherein the inversion of the potential field data includes an algorithm based on the regularized method, constrained by a priori information about the known contrast surfaces defined by seismology, and/or by drilling information, and /or by other geological/geophysical data

13. A system for terrain correction for potential field geophysical data comprising:
one potential field sensor; and
a computing system, the computing system comprising:
a processor; and
one or more physical non-transitory computer readable medium having computer executable instructions stored thereon that when executed by the processor, cause the computing system to perform the following:
measure at least one component of gravity and/or magnetic vector and/or tensor data with at least one potential field sensor in at least one measurement position along at least one survey line;
parameterize the 3D earth model in terms of multiple contrast surfaces between different geological formations;
characterize each geological formation by a density and/or magnetization and/or susceptibility value and/or function;
select an appropriate physical property function to describe the physical property distribution within each geological formation; and
invert the potential field (gravity and/or magnetic) data for the shapes of the multiple contrast surfaces between different geological formations.

14. The system of claim 13, wherein the plurality of potential field sensors include gravimeters and/or gravity gradiometers and/or magnetometers and/or magnetic gradiometers.

15. The system of claim 13, wherein the physical properties comprises one of density, susceptibility, and/or magnetization, representing the physical properties of the geological formations.

16. The system of claim 13, wherein the physical property function describing the physical property distribution within the geological formation is an analytic function of spatial coordinates.

17. The system of claim 13, wherein the forward modeling of the potential field data includes an algorithm based on Cauchy-type integral representations of the potential fields for each of the contrast surfaces.

18. The system of claim 13 wherein the inversion of the potential field data includes an algorithm based on the regularized gradient-type method, and the Frechet derivatives (sensitivities) of the data to the spatial points defining the contrast surface between two geological formations are derived analytically using Cauchy-type integral representations of the potential fields for each of the contrast surfaces.

19. The system of claim 13, wherein the inversion of the potential field data includes an algorithm based on the regularized method, constrained by a priori information about the known contrast surfaces defined by seismology, and/or by drilling information, and /or by other geological/geophysical data.

20. The system of claim 13, wherein the at least one potential field sensor comprises a plurality of potential field sensors arranged in an array.
